(19) United States
(12) Patent Application Publication
(10) Pub. No.: US 2024/0144228 A1
(43) Pub. Date: May 2, 2024

(54) Decentralized system for facilitating finding and recovery of lost and stolen properties

(71) Applicant: PABLO HERNAN ILARDO, CASEROS (AR)

(72) Inventor: PABLO HERNAN ILARDO, CASEROS (AR)

(21) Appl. No.: 18/120,466

(22) Filed: Mar. 13, 2023

Related U.S. Application Data
(60) Provisional application No. 63/421,218, filed on Nov. 1, 2022.

(51) Int. Cl. G06Q 20/28; G06Q 50/26; H04L 9/00

(52) U.S. Cl. CPC G06Q 20/28; G06Q 50/26; H04L 9/50

(57) ABSTRACT

Methodologies and systems disclosed herein are proposed to address a solution to facilitate finding and recovery of missing properties such as objects, devices, among others, by conforming both a decentralized system and a market comprised by the free interaction between owners of properties and agents that are willing to cooperate and work to find and retrieve lost and stolen items in exchange for a possible reward defined by the owners.

### CROSS-REFERENCE TO RELATED APPLICATIONS

The present application is based on and claims priority to U.S. Provisional Patent Application No. 63/421,218, having a filing date of Nov. 1, 2022, which is incorporated herein by reference in its entirety.

### TECHNICAL FIELD

Embodiments of the present disclosure relate to applications for facilitating finding and recovery of missing properties and, more specifically, to decentralized systems and applications for the fulfilment of the mentioned purpose.

### PRIOR ART

Based on research, a list of prior art in the field of systems for recovering missing properties is presented, together with the main issues found in those implementations.

US-20020066781 provides a manner for returning lost objects by finders and a way for letting a compensation reward be paid. However, a central organization is required and there are no relevant guarantees for finders of objects that the mentioned rewards will effectively be paid, especially if reward amounts are great enough.

US-20090014998 proposed a system for recovering lost objects via a clearance house which works as a connection between finders and owners of objects, ensuring reward payments in the system. However, the system acts as a centralized body which stores relevant information about owners like contact details and payment data and can constitute a target for attacks, leading to lack of confidence for using the system.

U.S. Pat. No. 9,569,950 proposed a system composed by an interactive voice response system, a server and a database for reporting found objects by finders and for communicating finder messages to owners so that anonymity of parties is ensured. However, interaction is poor, the system is centralized and no rewards can be properly guaranteed to finders for accelerating recovery.

US-20170228829 presents a system for providing some interaction between finders and owners of objects that ensures rewards can be paid and received, being the system monetized charging a fee after an object was recovered. However, the system is centralized, is supposed to be operated by an organization and could be vulnerable to be attacked or controlled by third parties, leading to lack of confidence for using the system.

US-20180227393 includes a Lost and Found server connected to several client devices via Internet to let potential finders know that an object has been lost in their proximity. The system includes interactive interfaces between owners and finders for validating found objects and arranging meetings for returning lost items. However, the system server is centralized and could be vulnerable to be attacked or controlled by third parties and no rewards can be properly guaranteed to finders for accelerating recovery, leading to lack of confidence for using the system.

US-20200004775 describes a network conformed by a system that acts as a middle man between finders and owners of objects considering encrypted communications, avoiding public information exposure from both owners and finders and thus gaining anonymity. However, the system is centralized and could be vulnerable to be attacked or controlled by third parties and no rewards can be properly guaranteed to finders for accelerating recovery, leading to lack of confidence for using the system.

### BACKGROUND OF THE INVENTION

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

Lot of things can be categorized in life as representing a value for their owners too much higher than its economic price. Pets, for instance, can easily be considered to form part of this concept since they are unique for their possessors. Other objects can also integrate this category, from a laptop PC with a last version of an unpublished studio and a cell phone with valuable personal information to a piece of art, a gift given by a grandfather or a childhood toy, among many other items. In cases as recently exemplified, owners could be voluntarily willing to offer some kind of compensation if their appreciated properties were found and retrieved when missing, even in many cases if they were stolen. When great margins exist between economic prices and psychological or emotional values, attractive rewards are also likely to be paid by owners to people to give their properties back. However, a transparent mean is needed to ensure transactions among parties take place in an orderly manner under certain arranged terms with an acceptable level of confidence and anonymity for all of them.

As already mentioned, prior art related to solutions for retrieving missing properties automates the recovery process via private servers and databases which ensures in some cases anonymity of users and the possibility of including find rewards. However, centralization of information and communication may put any system like those in a vulnerable situation regarding attacks by third parties. Additionally, the way to give confidence in relation to payments of find rewards is weak enough in such centralized systems since it depends on a unique entity that could remain highly unregulated for large periods of time, thus bringing uncertainty to payment transactions. Moreover, the existence of a middle system between owners of properties and potential finders discourages lots of recovery operations, especially in case of stolen properties.

There have been different ways in prior art systems for saving information about properties and its owners to let ownership be proved on the one hand and facilitate tasks in relation to the process for finding and recovering lost items. For instance, intradermic pet microchips have been traditionally flashed with codes containing 9, 10 or 15 characters and used for indexing data in private databases. More recently, QR codes have also been used in collars for identification. Direct mappings in prior art schemes from chip-stored pet ID codes to pet/owner data were classically used, being pet/owner data those features defining pets and owners' characteristics, such as owners' contact information. In such systems, both pet ID codes and pet/owner data are connected and stored in a private way.

In some systems of the prior art, if a property was lost and later found by someone, the finder could contact the database organization by reading some ID code, thus letting the owner know about the find event to start the recovery process. However, incentives for finding lost items were not well regulated and there were situations that left completely unmanaged. Sensitive information about the owner or the property was sometimes compromised, like the person's name or phone number and the item economic value.

In some cases of the prior art systems in which owners wanted to put a reward on findings, direct interaction between owners and finders was minimum and not dynamic enough and the recovery process used to be slow and stressful. Since the reward payment used to be somehow guaranteed by private organizations, there was doubt in relation to the money recompense to be correctly paid after the recovery of a property took place, thus discouraging operations. Additionally, since a central authority was in control of linking users, storing information and paying find rewards, recovery of stolen items was highly discouraged due to lack of confidence.

Interaction between owners and finders in systems so far was minimum and some specific terms for transactions were not capable of being customized. For instance, a dynamic reward related to the find process of a missing property was impossible or impractical to be set in many systems of the prior art since the central database regulation leads to low resilience and anonymity levels.

### SUMMARY OF THE INVENTION

The following presents a simplified summary of some embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Methodologies and systems disclosed herein are proposed to address a solution to facilitate finding and recovery of missing properties such as objects, devices, among others, by conforming both a decentralized system and a market comprised by the free interaction between owners of properties and agents that are willing to cooperate and work to find and retrieve lost and stolen items in exchange for a possible reward defined by the owners.

A decentralized system for facilitating finding and recovery of lost and stolen properties comprises one or more functions and variables to let a user register a property in the system by using an index associated to the property, one or more functions and variables to set the user as the owner of the property in the system, one or more functions and variables to let the owner report the property as missing in the system to account for situations of both lost and stolen properties, one or more functions and variables to let the owner store public and/or private information in the system for accelerating the find process of the property when missing and for retrieving and/or taking care of the property after found, one or more functions and variables to let an agent report the missing property as found in the system by using a find code and one or more functions and variables to let the owner report the missing property as retrieved in the system.

In other features, the system is deployed to a distributed ledger or blockchain for storing all variables and functions and for executing those functions. The distributed ledger comprises an adequate technology for reaching consensus about rights related to the system variables and functions through a suitable representation of them using smart contracts or similar approaches and a means for accessing the system by users that have the right to interact with the system for reading variables or executing some of its functions.

In other features, the decentralized system further comprises a set of functions and variables that can be used to reduce the probability of front-running in the system when reporting a missing property as found. The set of functions and variables comprises at least two routines that can be executed at different times by an agent willing to report the missing property as found in the system and a minimum predefined delay time between the execution of the two routines. In other features, the system further comprises one or more functions and variables to let the owner of the system charge some fees on certain operations in the system and withdraw its cumulated fees.

In other features, the decentralized system further comprises one or more functions and variables that can be used by the owner of the property to leave a find reward and one or more functions and variables that can be used by any agent after finding and retrieving a missing property to the owner in order to withdraw or donate the find reward if any.

In other features, the decentralized system further comprises one or more functions and variables that can be used by the owner of the property to modify a find reward if the associated missing property has not been reported as found till that moment.

In other features, the decentralized system further comprises one or more functions and variables that can be used by the owner of the property to partially or totally withdraw a find reward when applicable.

In other features, the different aspects for facilitating finding and recovery of missing properties are based on fixed recovery codes associated to those properties. The fixed recovery codes are supposed to be hard to be removed from the properties or replaced by other codes.

In other features, the different aspects for facilitating finding and recovery of missing properties are based on replaceable recovery codes associated to those properties. The replaceable recovery codes are supposed to be easy to be removed from the properties and replaced by other codes by the owners of those properties.

A method for facilitating finding and recovery of missing properties in a decentralized system comprises placing a fixed or a replaceable recovery code in a property for identification, registering a property in the system by a user via an index derived from the fixed recovery code if associated to the property or randomly selected otherwise, assuming that the user is the owner of the property in the system, using the index by the owner of the property if desired to reference public and/or private data associated to it in the system, reporting the property as missing by its owner for taking account of both lost and stolen properties, reporting the missing property as found by an agent using a find code and reporting the missing property as retrieved by its owner.

In other features, the method further comprises leaving a find reward in the system by the owner of a missing property if desired for it to be withdrawn by a future finder of the property after being reported as retrieved and withdrawing or donating the find reward if any by the finder of the property after being reported as retrieved.

In other features, the method further comprises modifying the find reward associated to a missing property by its owner when applicable.

In other features, the method further comprises withdrawing partially or totally the find reward associated to a missing property by its owner when applicable.

In other features, the method further comprises some steps for avoiding front-running in the system when reporting a missing property as found by an agent.

In other features, the method comprises storing public information in the system by the owner of the property if desired related to it and/or its owner or publishing a link that refers to the mentioned information externally stored and using the public information if desired for accelerating the find and/or recovery process of the property when missing and/or for taking care of the property after being found. In other features, the public information can be modified by the owner of the property. In other features, the method further comprises storing private information in the system by the owner of the property related to it and/or its owner or publishing a link that refers to the mentioned information externally stored and using the private information by the owner of the property if desired for accelerating the recovery process of the property and/or for taking care of the property after being found. In other features, the private information can be modified by the owner of the property.

In other features, the method further comprises generating a private key, a set of find codes and an index derived from a fixed recovery code if placed in a property, using the private key by the owner of the property to encrypt information related to it and/or its owner if desired, using the index by the owner of the property if desired to reference data associated to it in the system after the property was registered and using the find codes by finders of the property for reporting the property as found when missing at different times.

In other features, the method further comprises generating a private key, a find code and an index derived from a replaceable recovery code if placed in a property, using the index by the owner of the property if desired to register it in the system, using the private key by the owner of the property to encrypt information related to it and/or its owner if desired, using the index by the owner of the property if desired to reference data associated to it in the system after the property was registered and using the find code by a finder of the property for reporting the property as found when missing.

A method for placing a replaceable recovery code in the lock screen of a device for identification and recovery of the property when missing comprises generating a random code and deriving a graphic representation of the code through an app installed in the device, placing the graphic representation of the code in a secondary hidden lock screen of the device, using the graphic representation of the code by an eventual finder of the device for facilitating the recovery of the missing property and replacing the code and its graphic representation in the secondary hidden lock screen of the device by a new code after recovery.

### BRIEF DESCRIPTION OF THE DRAWINGS

To facilitate a full understanding of the present invention, reference is now made to the accompanying drawings, in which like elements are referenced with like numerals. These drawings should not be construed as limiting the present invention but are intended to be exemplary and for reference.

FIG. 1 is a schematic diagram of an embodiment of a decentralized system for facilitating the recovery of properties with N owners of objects and M agents acting as finders, interacting with the decentralized system through some cell phone recovery app.

FIG. 2 is a scheme of a practical demonstration for the inclusion of a replaceable recovery code in a hidden part of a cell phone lock screen or similar devices (e.g., tablet), so that it can be accessed by a potential finder of the lost or stolen property to publicly report it as found in possible embodiments of the current disclosure.

FIG. 3 is a scheme of a pet collar containing a replaceable recovery code printed on its backside, so that it can be accessed by a potential finder to publicly report the pet as found in possible embodiments of the current disclosure.

FIG. 4 is a scheme to show the methodology of one or more embodiments applied in the recovery process of a lost or stolen property with an associated replaceable recovery code. Different steps are considered to derive a private key for encrypting/decrypting owner's data, a find report code for reporting the property as found and a public verification code used in the recovery process for verification.

FIG. 5 is a scheme to show the methodology applied in the recovery process of a lost or stolen property in some embodiments to let a property's finder access contact details of an object's owner for retrieving the found property. The owner's contact details can be encrypted with a private key by the owner, then published on the Internet and afterwards be decrypted by the object's finder to arrange the retrieval of the property.

FIG. 6 is a scheme to show the methodology proposed in some embodiments for generating public indexes from fixed recovery codes associated to properties via a public index derivation algorithm composed by a slow key derivation algorithm and several hash routines. Public indexes are utilized for mapping data in the decentralized system and for the find verification process.

FIG. 7 is a scheme to show the methodology in some embodiments for deriving a public index variable from a fixed recovery code associated to a property. A slow key derivation algorithm is used for obtaining a private key used for encrypting/decrypting contact details of the property's owner. Then a hash chain is leveraged for generating a set of find report codes and a public index variable.

FIG. 8 is a comparison between some classical prior art schemes utilized for privately mapping chip-stored ID codes to data from properties and their owners and a scheme to show the methodology of some embodiments of the current disclosure for mapping data in a decentralized system and encrypting sensitive data from owners.

FIG. 9 is a schematic diagram of the workflow of some embodiments for developing a backend decentralized system running on top of a distributed ledger or smart contract blockchain.

FIG. 10 is a schematic diagram of the time evolution for the recovery process in some embodiments for finding and retrieving lost and stolen properties, composed broadly by a searching phase, a restoring stage and a period for claiming a reward.

FIG. 11 is a schematic diagram to account for the steps a finder of a lost or stolen property has to follow for retrieving the found item according to some embodiments.

FIG. 12 is a diagram with an initial approach for presenting and categorizing public and private variables in various embodiments.

FIG. 13 is a diagram of different sections of the main smart contract of some embodiments for defining a decentralized recovery system running on top of a smart contract blockchain.

FIG. 14 is a diagram with code sentences for declaring unsigned integer variables, events and data structures of the main smart contract for defining a decentralized recovery system according to some embodiments.

FIG. 15 is a diagram with code sentences for defining mapping variables, a constructor and some functions of the main smart contract for defining a decentralized recovery system according to some embodiments.

FIG. 16 is a diagram with code sentences for defining some functions (i.e., setOwnerData, transferObjectOwnership, objectLost) of the main smart contract for defining a decentralized recovery system according to some embodiments.

FIG. 17 is a diagram with code sentences for defining some functions (i.e., antiFrontRunning and objectFound) of the main smart contract for defining a decentralized recovery system according to some embodiments. The mentioned functions can be executed by an object's finder for reporting an object as found in the systems of those embodiments.

FIG. 18 is a diagram with code sentences for defining some functions (i.e., objectRestored and claimFindReward) of the main smart contract for defining a decentralized recovery system according to some embodiments.

FIG. 19 is a diagram with code sentences for defining some functions (i.e., changeFindReward, sendMessage, withdrawFees, receive and fallback) of the main smart contract for defining a decentralized recovery system according to some embodiments.

FIG. 20 is a diagram with code sentences defining an ERC-20 simplistic smart contract token representing an example of stable token currency that can be used for making payments in some embodiments.

FIG. 21 is a schematic diagram of the workflow of some embodiments for developing a backend system running on top of a distributed ledger or blockchain and a frontend system running on a web server, including stages for doing tests and correction of errors.

FIG. 22 is a diagram containing the main functions to be executed from a generic ERC-20 token smart contract to allow token payments according to some embodiments.

FIG. 23 is a diagram for describing how an anti-front-running code may be generated in some embodiments by the finder of a lost or stolen property for preventing front-running when reporting some property as found.

FIG. 24 shows a web site section of the frontend of one embodiment for registering new properties by their owners.

FIG. 25 shows a web site section of the frontend of one embodiment including functions that can be executed by owners of properties for reporting properties as lost and restored, and for changing find rewards.

FIG. 26 shows a web site section of the frontend of one embodiment including functions that can be executed by finders of missing properties for reporting properties as found and for claiming find rewards.

### DETAILED DESCRIPTION OF THE INVENTION

This section is intended to provide explanation and description of various possible embodiments of the present invention. The embodiments used herein, and various features and details thereof are explained more fully with reference to non-limiting embodiments illustrated in the accompanying drawings and detailed in the following description. The examples used herein are intended only to facilitate an understanding of ways in which the embodiments herein may be practiced and to further enable the person skilled in the art to practice the embodiments used herein. Also, the examples/embodiments described herein should not be construed as limiting the scope of the embodiments herein. Corresponding reference numerals indicate corresponding parts throughout the drawings.

In some embodiments of the present disclosure, one or two types of possible identification strategies can be used for facilitating the recovery of missing properties by leveraging a recovery code associated to each item. The first identification type comprises the use of replaceable recovery codes (e.g., bar codes, QR codes, etc.) that can be generated and printed into physical or electronic tags. In this context, an electronic tag could be for example a QR code included in the lock screen of a device, such as a cell phone or a tablet, among others. Such a replaceable recovery code can be changed by the owner of the property whenever wanted. The second identification type comprises the use of fixed recovery codes that are unlikely and hard to be replaced by users, like the codes inserted into intradermic chips for pet identification, among many others.

In the description of embodiments that follows it's considered that all interactions between owners of properties and finders with the system for facilitating the recovery of properties is done via a cell phone or web site app or other similar interactive platform with a friendly user interface to let interactions be enhanced.

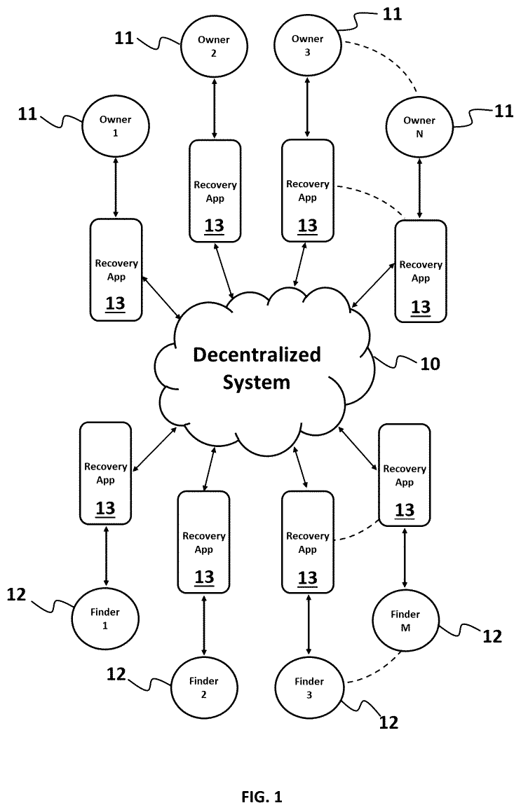

In FIG. 1 a schematic simplistic diagram of one embodiment is shown comprising a decentralized system 10 for facilitating the recovery of missing properties with N owners of properties 11 and M agents acting as finders 12, interacting with the decentralized system via some cell phone recovery app 13. In the mentioned scheme, there is no central authority to control interactions between users since the system 10 is distributed. The mentioned system 10 is supposed to be defined and controlled by a high number of independent parties to set environment rules that regulate property rights in the system and requirements to manage interaction between agents. People skilled in the art will notice that those decentralized systems can be constituted for example by some distributed ledgers or blockchains established by numerous independent agents.

In the context of some embodiments of decentralized systems as the one shown in FIG. 1, rewards could be paid by owners of properties to finders as a compensation for their work, after properties reported as missing are correctly found and retrieved. The existence of the mentioned compensation amount can be guaranteed by the decentralized system itself in some embodiments if the owner of a property locks a certain amount of money as a find reward in the system. Therefore, a finder of the property may be pretty sure of being able to withdraw the compensation after the found item is returned since the working of the decentralized system is guaranteed by a large number of independent agents.

Before or after a certain property is missing, its owner can register it in one or more embodiments by using a cell phone app or through a web site and report the property as lost when needed, setting a find reward if wanted and including some public information if desired to accelerate recovery such as some property's features and data related to the way it got lost like time and place of the event. Private sensitive information related to the owner's contact details can be keep out of the system if chosen until the object is finally found.

Once the property is found by an agent, the owner can register its contact details in an encrypted way in some embodiments through the mentioned app or web site to be accessed by the property's finder. By using the app or web site, the finder of the property can also send a find alert to the community and also to the object's owner by prior scanning the property recovery code that identifies it. Additionally, the finder of the property may decrypt and access the owner's contact details deriving a password from the property recovery code. After the property was successfully retrieved, the owner can inform the event to the system executing a function in some embodiments, thus letting the finder withdraw its find reward if applicable.

An environment and a market can then be created based on some embodiments in which owners and finders of properties are able to freely interact with proper incentives for finding and recovering items in a decentralized way. Since find rewards are proposed to be paid via a decentralized system, a high level of anonymity can be reached regarding payments, thus encouraging more operations to take place in relation to systems of the prior art.

According to the present disclosure, for a lost property to be found, prior identification of the property via recovery codes is a fundamental aspect. In order to address identification of a property, an exclusive kind of pattern can be previously got from the item and saved as unique fingerprints of it when they are distinguishable from others. In other cases, it is possible to use identification codes attached to the properties, so that they can be read by an eventual finder. A methodology can be considered in different implementations to let a finder of a property identify it, fill a find report, access some information to contact the owner and return the property back, among other operations, in a decentralized way.

In various embodiments like the one schematically shown in FIG. 1, it is also desired that all users in the system can be conscious of losing and find events for a certain lost item but only the owner and the finder of the property are able to access relevant information for retrieving the article.

As already mentioned, two approaches can be considered in embodiments of the present disclosure regarding physical identification of properties. The first strategy relies on replaceable identification codes like those that can exist in personal objects (e.g., cell phone, baggage, etc.), while the second strategy is based on fixed identification codes like those that can be present in hardware (e.g., intradermic chips for identifying pets, among others). Some embodiments can work with one or both of the mentioned strategies which can be finally selected by brands and users based on the privacy and interaction levels they are expecting to get.

As was stated, some embodiments can leverage the use of replaceable codes for facilitating the recovery of missing properties. Therefore, let's suppose first that the identification for recovering an object relies uniquely on a code (e.g., QR) printed on a tag attached somehow to that object. The code is supposed to be available to be read by some cell phone camera when a person finds the missing item, so that the code can be used to report the object as found. However, it should be hidden enough in the object or device so that there is no way for a third party to report the object as found just by watching the item or taking a picture of it. The replaceability of the mentioned code also permits the owner of the object to replace such code after each time the object is lost and found.

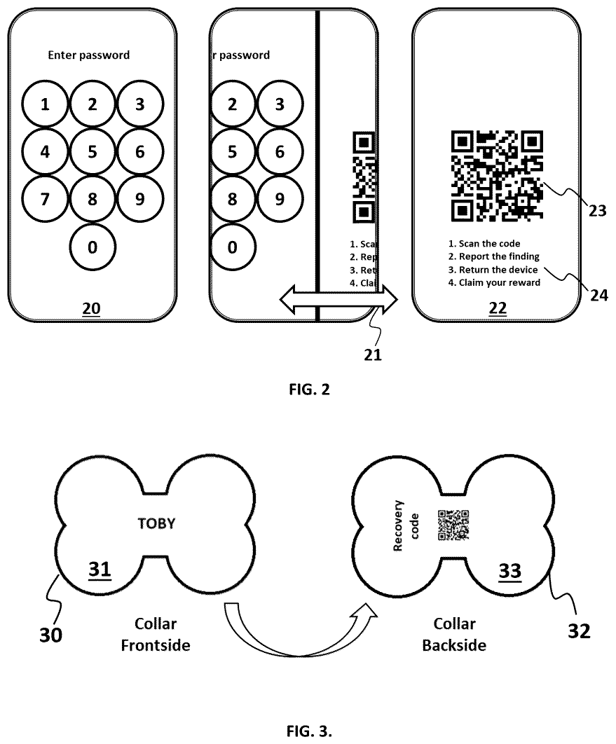

In FIG. 2 the main lock screen of a cell phone 20 is shown and the appearance of a graphic representation 23 of a 32-bytes code for recovering the device together with some instructions 24 may be done by shifting the screen to the side in step 21 and letting a secondary hidden lock screen 22 be shown. The mentioned code 23 can be scanned in some embodiments by anyone who finds the item and it can be set and changed by the owner when desired or after a missing property was recovered. The method of shifting the main lock screen in step 21 for displaying the recovery code and instructions proposed here can be considered in some embodiments as a way for avoiding a third party from knowing the recovery code just by observing the device's lock screen, among other ways. Besides shifting the main lock screen, the recovery code may appear in other embodiments through a certain combination of pushed buttons, among other similar strategies. Replaceable codes like 23 for identifying and recovering properties are called herein “replaceable recovery codes” and can be randomly selected by owners of properties and used by finders for filling find reports associated to missing items in various embodiments. In practice, a proper app installed in devices may be used in some embodiments by owners for being guided in the creation of recovery codes and in the inclusion and replacement of their graphic representations in devices.

In FIG. 3 the front side 30 and back side 33 of a classical pet collar is shown as an example for being used in relation to various embodiments. The pet's name 31 can be read at the front side 30, while a recovery code 32 can be found at the back side 33.

In both cases exemplified by FIG. 2 and FIG. 3, the recovery codes can be changed by the property's owner whenever wanted, at the sole cost of replacing the old electronic or physical tag by another one. A replaceable recovery code can be associated to a property in such a way that it keeps unknown by externally watching the item or a picture of it, while it can be easily accessed by an eventual finder by simply shifting a screen, turning around a tag or removing an adhesive opaque label put on top of the tag with the recovery code, among many other options.

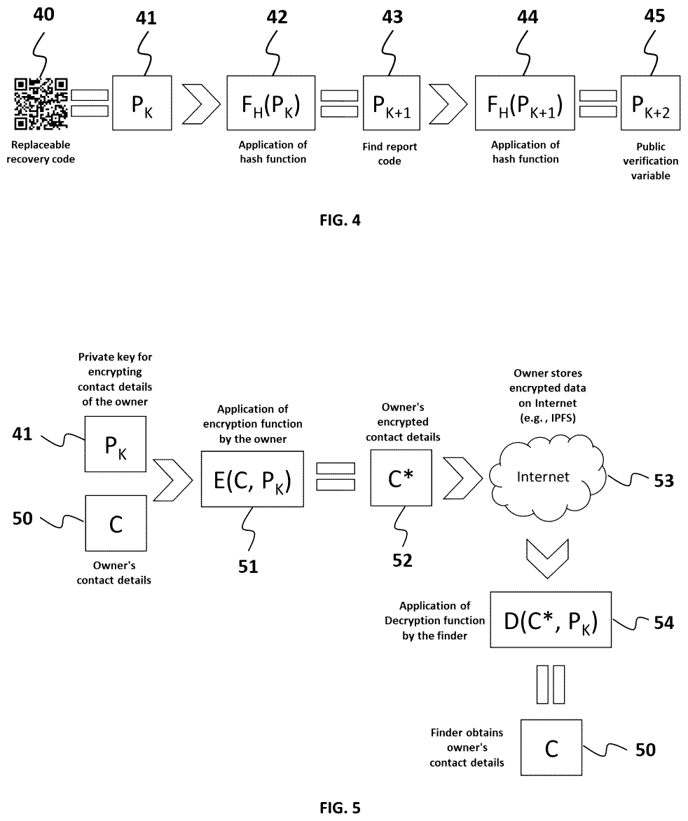

In various embodiments, a method can be considered to use replaceable recovery codes for filling find reports of missing properties by agents. In FIG. 4 a scheme is shown for using a replaceable recovery code 40 in some embodiments for reporting a finding. If the code is long enough (e.g., 32 bytes) and randomly selected, it can also be used as a private key 41 for encrypting the owner's contact details to facilitate recovery of the property. If a hash function 42 is applied on the private key 41, a new code 43 is obtained, called herein “find report code”. The find report code 43 allows the finder of an item to publicly report the later as found in the system in some embodiments. If a hash function 44 is applied on the find report code 43, a new code 45 can be obtained and used as a public verification variable in various embodiments at runtime. Therefore, if the owner of a property selects randomly a recovery code 40 and both hash functions are publicly known by all agents in the ecosystem, both the owner and an eventual finder of the property can obtain first the private key 41, and then the find report code 43 and the public verification variable 45 by solely applying the mentioned hash functions a couple of times.

The method proposed to be used in various embodiments comprises a first stage for publishing a public verification variable in the decentralized system by the owner of a property after it's been lost. If a finder finds the item after that, the finder can scan the recovery code and apply the same known hash functions to generate both the find report code and the verification variable. As the system is supposed to be public for a lot of agents in mentioned embodiments, at that moment the finder is able to check if the verification code obtained after said calculations matches some public verification variable published by some property's owner. If variables match, then the finder can get data related to the item (e.g., object's characteristics, find reward amount, etc.) and use the find report code to report the object as found in the system.

All above-mentioned operations related to actions of owners and finders can be put in practice in various embodiments by using a proper cell phone or web site app by both owners and finders, with an adequate user interface to let people's labor be minimal.

Hash functions proposed above for being used in some embodiments for generating both find report codes and public verification codes are those that are hard to be inverted (e.g. KECCAK-256), so that any other agent in the system except for the owner and the finder can neither generate find report codes based on public verification variables nor recovery codes from find report codes.

The decentralized system proposed to be used in various embodiments may be a system capable of verifying that some lost or stolen property has been successfully reported as found by performing a calculation in a decentralized way (e.g., using smart contracts on a blockchain) of the same hash function considered by the owner of the item to obtain the public verification variable, using as an argument the find report code provided by the finder, among other possible data. If the result of the decentralized system hash calculation matches the public verification variable previously published by the owner, then the property can be formally considered as found by the system in those embodiments.

A method that can be considered in some embodiments can be used for establishing a link between owners and finders to let them privately meet so that lost and stolen items can be physically retrieved. In FIG. 5 a scheme is shown with a method of some embodiments comprising a set of steps to share contact information from owners with finders in an anonymous way. Before or after the owner of a missing property realized that someone found the item through some system alert, the owner can encrypt via some user app part of its contact details 50 using its private key 41 and some encryption function 51 (e.g., AES-256) and store the encrypted data 52 on the Internet (step 53), publishing a link to the encrypted data as a system variable. Data to be encrypted and stored can be whatever information the owner wants to share with an eventual finder (e.g., e-mail address, place and time for a meeting, a phone number, the name of a certain external organization if more privacy is preferred, etc.). Encrypted contact data can also be stored by the property's owner in some decentralized way (e.g., using IPFS) via a proper user app in some embodiments, so that the whole methodology doesn't depend on a single server. Contact details of the owner can also be stored in the system in plaintext format in other embodiments although anonymity can be jeopardized. As the finder of the item is perfectly capable of deriving the same private key from the scanned recovery code via a user app in some embodiments, the finder is also able to use the app to decrypt the encrypted information obtained from the Internet using the proper decryption function in step 54 and thus obtaining the owner's contact data 50. After some physical communication channel between the finder and the owner has been activated, the owner can stop publishing its encrypted contact details on the Internet. As mentioned, in different embodiments the privacy and type of the owner's published data depends entirely on the owner's will. If some owner wants complete privacy, a time and a public secure place (e.g., police station, governmental office, etc.) can instead be published for arranging a meeting between parties.

Regarding objects identified with replaceable recovery codes that can be considered in some embodiments, it is recommended that owners change mentioned codes each time missing properties have been recovered. If not, the next recovery process for those items in the future could be threatened.

The second approach for identifying and facilitating the recovery of properties in some embodiments relies on fixed non-replaceable recovery codes, like those that can be stored in a hardware device (e.g., pet intradermic microchips, among others). Fixed codes can also be derived from special patterns of properties used to distinguish them (e.g., fingerprints or DNA in humans). In the following description, the terms “fixed non-replaceable code” and “fixed code” are used equally for referring to an identification code associated to a property which is difficult and unlikely to be removed and/or replaced by another code. Methods can be considered in some embodiments to use fixed non-replaceable codes as recovery codes for both identifying properties and reporting findings in decentralized systems.

Let's suppose in this point that the identification for facilitating the recovery of an object in one or more embodiments relies only on a fixed code, such as the one inside a chip installed in a hardware device. By definition, codes inside those chips are difficult to be replaced by owners and the same codes must be effective for both identification and recovery processes at different times, since a certain property could be lost and found more than once with the same fixed code.

Chips with fixed codes are usually read by special scanning devices (e.g., using NFC technology). For instance, intradermic chips for identifying pets can easily be scanned in most vet offices or in some government institutions.

Since information for feeding both identification and recovery stages must be derived from the same fixed code, a methodology can be used in some embodiments of decentralized systems to let agents report the finding of the same object at different times without problems using the same fixed code, protecting contact details of owners and avoiding false alarms on findings as much as possible.

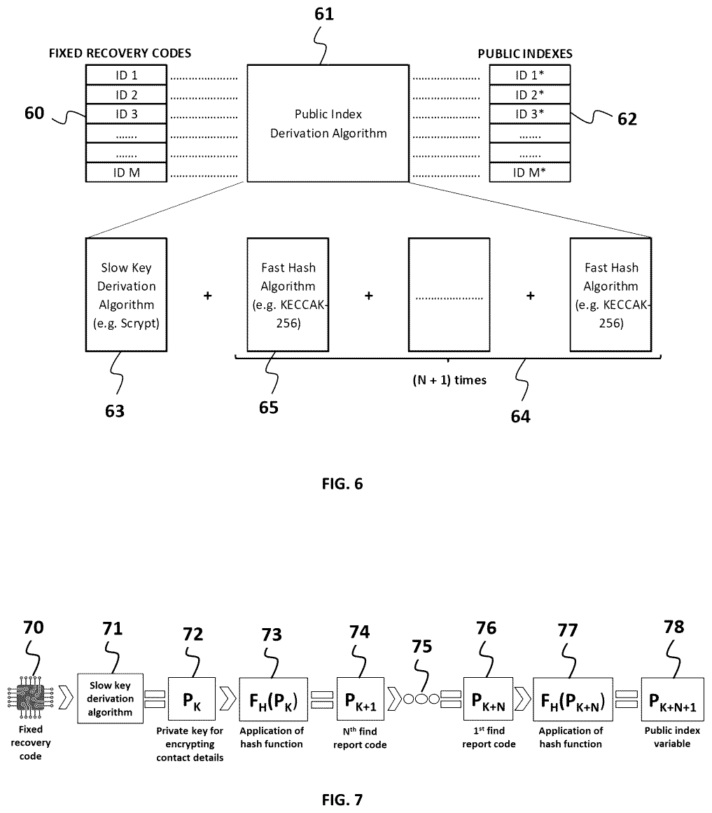

In FIG. 6, a derivation of public indexes 62 from fixed recovery codes 60 than can be considered in some embodiments is shown. The scheme is composed by some routines including a hash chain 64, where the algorithm 61 for derivation of public indexes is split in FIG. 6 into its main components for clarification. Since some old chips used to have 9-character codes or less, a slow key derivation function 63 is considered in the first stage of the process to avoid possible external attacks in some embodiments by randomly trying chip codes to generate the whole hash chain (e.g., using GPU, FPGA or ASIC, among others). The above-mentioned slow key derivation algorithm (e.g., Scrypt) accounts for a possible solution to the later issue, ensuring that a minimum calculation cost is needed, as people skilled in the art will notice.

At the end of the proposed hash chain, public indexes 62 can be obtained in various embodiments after the N+1 hash function calculations 64, being N the given maximum number of times a certain property can be lost and found in the decentralized system. Therefore, for a certain fixed code, a public index may be obtained which can be used for mapping public data in the system.

Hash functions 65 proposed in the mentioned scheme of FIG. 6 for chain generation in various embodiments are those that are hard to be inverted (e.g. KECCAK-256). If hash functions are wisely selected, then the knowledge of the N^{th} hash calculation won't allow anyone to predict the output of the N−1^{th} hash function. In those embodiments, hash functions are also supposed to be calculated by the decentralized system at runtime for verification purposes.

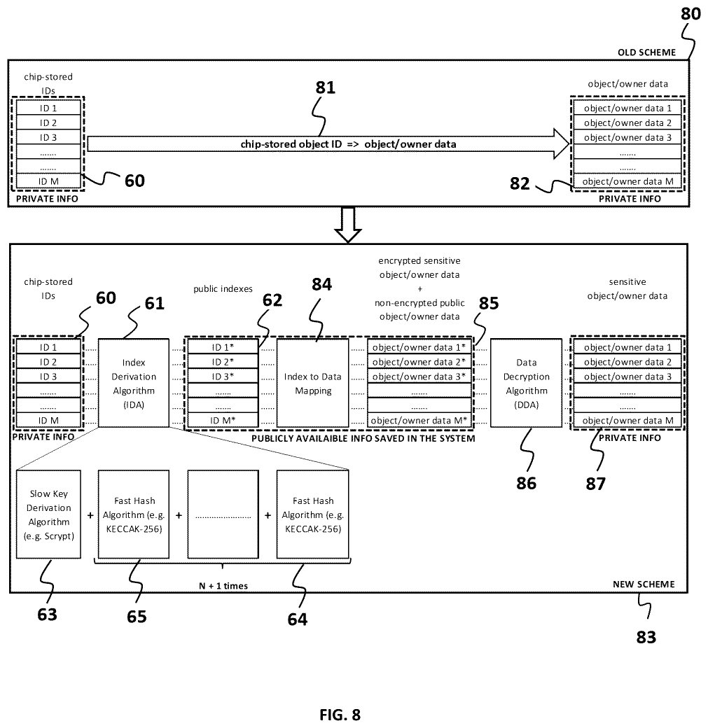

In FIG. 7 the methodology leveraged in some embodiments of the present disclosure is shown for getting a public index 78 and N find report codes from a fixed recovery code 70, being N the maximum number of times a property can be lost and found in that system. In such scheme, the output of the slow key derivation algorithm 71 is considered to be the private key P_{K} 72 used eventually to encrypt data through a user app in some embodiments by the owner of the property to arrange a meeting with an eventual finder, through the same process already shown in FIG. 5 to anonymously share contact information from owners with finders. By the application of the hash function at step 73 on the private key P_{K} 72, the N^{th} find report code 74 is obtained that may be used for reporting the finding of that property when missing for the N^{th} time. By the application of the same hash function repeatedly on the last obtained find report code, a hash chain 75 can be established till getting the find report code for reporting the property as found for the first time 76 and deriving the public index of the property in the system 78 after the application of the last hash routine at step 77. People skilled in the art will notice that the sole knowledge of a certain find report code doesn't let any agent obtain other find codes for being used in the future in mentioned embodiments, since the hash function F^{H} is selected as hard to be inverted. Therefore, both the private key P_{K} 72 and future find report codes remain unknown after reporting an item as found for everyone except for the owner of the property and previous finders.

If the above criteria for hash functions are met, then the first N hash codes generated in FIG. 7 can be utilized for publicly filling find reports in some embodiments. In order to clarify the recent statement, let's suppose that a public index obtained at the end of calculations from a fixed recovery code is stored in the system as a public variable for identifying a pet with an intradermic chip and the associated pet was lost for the first time. Moreover, let's suppose the owner used an app to offer a find reward in an embodiment of a decentralized recovery system when reporting the pet as lost. If someone finds the pet and scans the intradermic chip code, the whole hash chain of FIG. 6 can be easily reproduced in such embodiment through the user app. After arriving to the last step of calculations (i.e., after N+1 hash computations), the public pet index 78 can be got and public associated data can be accessed by the finder through the app. As a find reward was offered, the finder can use the output of the N^{th} hash function 76 as the find report code to alert the system through the app about the finding and thus claiming for the reward payment. As was said, the decentralized system of different embodiments should be chosen to be perfectly capable of verifying if the hash function calculated on the input find report code equals to the public index of the property. If so, the pet can be assumed by the system to be officially found and the pet owner can be informed via some user app alert to publish its contact details for arranging a meeting. In the later example, although the N^{th} find report code was made public by the finder, there is no possibility for other agents to generate the N−1^{th} hash code with exception of the finder and the owner itself. The later statement means that if the same pet is lost in the future for a second time, the next finder would be capable of successfully reporting the finding and claiming its reward if any, following the same procedure as recently described but using the N−1^{th} hash code as the find report code through the user app. The number of times each property was already lost and found should be stored in different embodiments as a system public variable and the maximum number of times an item can be lost and found is also supposed to be publicly known. So, if a finder gets first the public index of a missing property after generating the whole hash chain with some user app, the app routine is supposed to know which find report code to use for successfully reporting the finding.

Regarding the possibility of contacting the owner for returning a property with a fixed recovery code, in various embodiments the same private key P_{K} 72 must be used at different times the item is lost for encrypting and decrypting data from the owner. The later means that encrypted data from a certain owner may be accessed by all previous finders of the respective item each time the property is lost and some encrypted data is published. However, for solving that issue, owners are free to create and share new communication channels at each time (e.g., creating and sharing new e-mail accounts) and also to use external organizations for being contacted. For instance, most pet owners leave contact information to private or public organizations in case their pets are lost after installing intradermic chips in their pets. If that's the case, then the public pet index obtained by an eventual finder of a lost pet through a user app can be leveraged in some embodiments for getting public information of such organization or company, such as the name, address or phone number. If no company or agency holds the owner's contact data, as a last resource direct plain or encrypted messages may be sent in some embodiments by both the finder and the owner via the user app to arrange a meeting.

The described scheme using fixed non-replaceable codes can work perfectly in various embodiments as long as codes remain secret and previous finders don't act in a malicious or unproper way. If there is no leak in information regarding fixed codes, no false find alarms are supposed to be issued. Therefore, the probability of failure associated with fixed recovery codes is really low and benefits may be supposed to be much greater than potential risks in some embodiments.

In FIG. 8 a diagram is presented to show the main differences between prior art schemes 80 and the scheme 83 of some embodiments of the current disclosure for representing recovery systems using fixed codes for identifying and retrieving missing properties. In FIG. 8 old private systems are represented by a mapping 81 between fixed codes 60 and data related to both properties and owners (object/owner data 82). However, in various embodiments of the present disclosure a mapping 84 exists between public object indexes 62 and encrypted object/owner data 85. Since encryption of some fields of object/owner data 87 may be highly desired to get anonymity, an extra routine regarding the cryptography state-of-the-art (e.g. AES-256) may be considered in some embodiments when saving private information in the system or in the Internet by owners using a proper app. In that case, Data Decryption Algorithm 86 in the scheme of FIG. 8 can be a secure decryption process (e.g., AES-256 decryption algorithm).

In various embodiments, stored information related to owners of properties can be encrypted when sensitive whenever they want, increasing security and letting more operations take place with transparence.

In FIG. 8 Index Derivation Algorithm 61 is the already mentioned routine that can be used in some embodiments to obtain public indexes 62 from identification recovery codes 60. As was explained, hash routines 64 can also take care of a possible situation in which a property is missing more than once although all past findings have already been publicly reported in the system.

As previously mentioned, selection of a proper hash function used for feeding the chain of FIG. 8 to obtain public indexes has two relevant related criteria to be met for different embodiments: the function must be hard to be inverted and the decentralized system must be capable of performing online calculations of the same function. For instance, if the Ethereum blockchain is selected to be both the backend processing system and the system database for executing the logic in some embodiments, the KECCAK-256 hash function can be chosen as the hash function routine to be selected in all cases mentioned so far. However, if the implementation in other embodiments is made on top of another distributed ledger or blockchain, a suitable hash function must be selected for verification purposes taking into account the above-mentioned requirements.

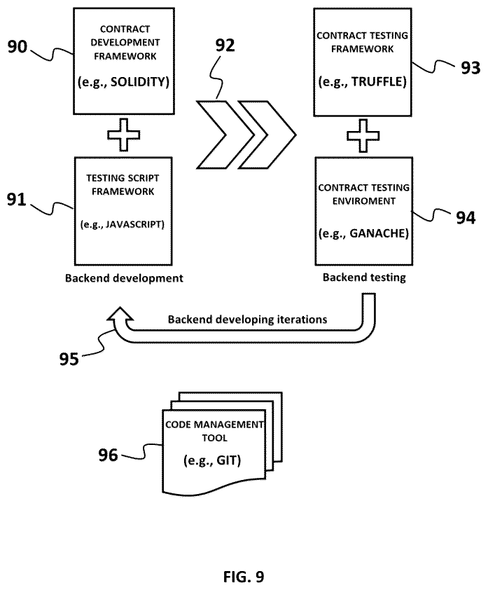

In FIG. 9 a flow diagram is presented as a possible implementation of the system backend in some embodiments using Ethereum as a smart contract blockchain to show an example of implementation for both the decentralized system and methodologies proposed in the present disclosure. The main smart contract code can be written based on a smart contract development framework 90 (e.g., using Solidity language) and backend tests can be performed on a testing framework 91 via coding some testing scripts (e.g., using Javascript language). A test step 92 may take place where a contract testing framework 93 (e.g., Truffle) can be used together with a contract testing environment 94 (e.g., Ganache) for migrating contracts and running testing scripts in some embodiments. A Git repository 96 can be considered as a way for tracking code version changes and a feedback loop 95 can be included in the workflow to find and correct code bugs.

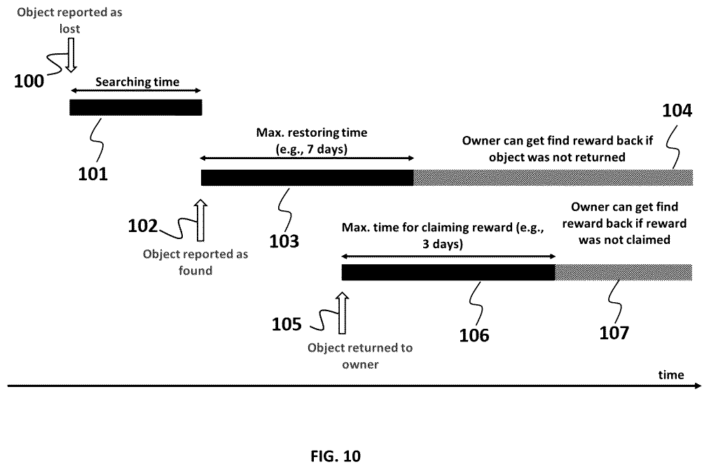

Considering both property identification strategies to facilitate recovery of properties in different embodiments (i.e., using replaceable and fixed recovery codes), time evolution of the recovery process for lost items can be divided into the stages schematically shown in FIG. 10. When a property is reported as lost by its owner at step 100 using some user app according to some embodiments, the searching time 101 takes place. In one or more embodiments, maximum searching time can be set by owners by simply reducing or removing find rewards at a certain desired time. When some item is found by someone and reported as found in the system using the user app (step 102), the finder has a certain maximum time 103 previously set for retrieving the item. If time goes by beyond the maximum restoring time, the owner can get the find reward back or reduce it in some embodiments (step 104) to penalize the finder or to account for atypical situations in which finders report properties as found but don't take them back to their owners. If items are successfully returned to their owners and owners alert the system about that (event 105), in some embodiments finders have a certain amount of maximum time 106 set in the system (e.g., 3 days) for claiming find rewards if applicable. Last mentioned situation also accounts for finders that don't want to earn any compensation amount for their actuation. In those cases, owners can get find rewards back in some embodiments after some time (step 107). During the period of time 106, owners are not allowed to declare the same items as lost till finders claim for their rewards for avoiding an abnormal situation in the decentralized system in which there is an overlapping between new finders and old ones. Apart from the above-mentioned steps regarding the recovery process, in some embodiments the property's owner is allowed to report the item as recovered whenever desired to consider a situation in which an item returns to its owner by itself (e.g., a pet returning home). The mentioned values of times can also be defined in some embodiments by the owners of properties when reporting them as missing.

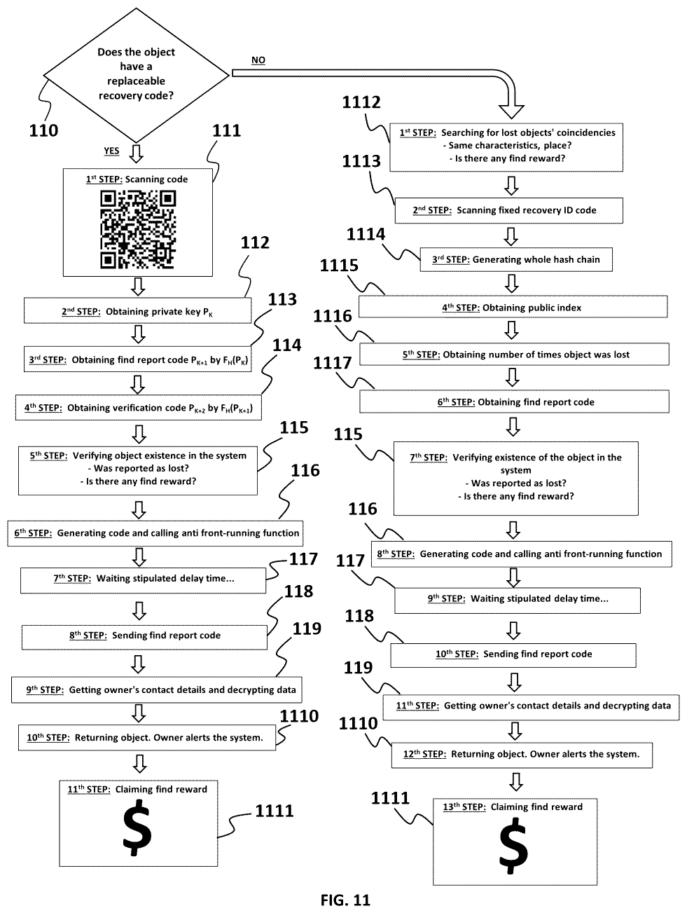

In FIG. 11 the recovery scheme of various possible embodiments is shown from the point of view of an object's finder. Like previously said, system operations shown in FIG. 11 are supposed to be done by owners and finders through user apps in different embodiments. At step 110, the finder of an object may identify whether the object has a fixed or replaceable recovery code. If a replaceable code 40 is present, the finder can scan the code at step 111. When the replaceable recovery code is known, the finder can get the private key P_{K} 41 at step 112, obtain the find report code 43 at step 113 and a verifying code at step 114 by performing proper hash calculations, as mentioned. The finder's app can compare the verifying code obtained with the public verification variable 45 previously published by the object's owner at step 115. At that point, public information regarding the status of the object can be obtained by the finder using the app, like the amount of a potential find reward and relevant characteristics of the object, such as medicines a lost pet needs to take. At step 116 the finder can generate a specific code named herein “anti-front-running code” useful for some embodiments and execute a correspondent anti-front-running function on the system before reporting the object as found. This is to account for a possible situation in which some embodiments whose decentralized systems are placed on top of certain ecosystems (e.g., Ethereum blockchain) have some risk that a third party can concrete the operation before the finder, since transactions may be waiting in a transaction pool for several minutes till being effectively executed. Therefore, an anti-front-running routine can be used in various embodiments to prevent such situation. A detailed explanation about anti-front-running routines and the generation of anti-front-running codes by object's finders will be explained later. After waiting some preset delay time related to the anti-front-running method at step 117 (e.g., 1 hour), the finder can report the object as found in the system sending the find report code (step 118). After the owner has published some encrypted information like contact details if desired, the finder can get the published data, decrypt its content at step 119 using the private key 41, get contact details and then retrieve the object to its owner, who may execute a function to alert the system about the recovery (step 1110). Finally, the object's finder is permitted to withdraw its find reward if any from the decentralized system at step 1111.

Coming back to step 110, if the object has instead a fixed non-replaceable code or no code is easily detected, the finder can also use a user app in some embodiments to perform an initial search on objects reported as missing in the system near the place of discovery at step 1112 to look for coincidences in the public system information. If some object reported as missing matches the found item, the finder can get the code scanned at a proper place or office (step 1113). In order to accelerate recovery, owners can also publish some public addresses where chips can be scanned at the moment they report their properties as missing. After the fixed recovery code 70 was properly read, the finder is capable of generating the whole mentioned hash chain 64 via the user app at step 1114 after some hash calculations. At step 1115, the finder can get the public object index 78. After that, the finder may get the number of times the object with fixed recovery code was already lost and found (step 1116). The finder may then obtain a valid find report code at step 1117 and then verify public published data of the object (step 115). After completed step 115, the finder can follow steps 116, 117, 118, 119 and 1111 to report the object as found and withdraw the find reward if any as was previously described for replaceable recovery codes. As a recall, all above-mentioned system calls are supposed to be done via user apps by both owners and finders in different embodiments, so that their labor is reduced.

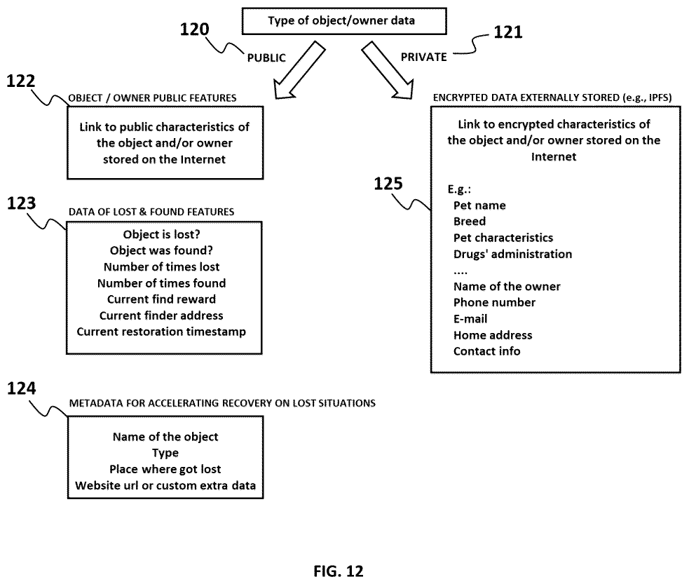

In FIG. 12 it can be seen how data related to properties and owners (object/owner data) can be split in some embodiments into two categories: public 120 and private 121. Public data 120 can be divided for example into public features 122 published on the Internet, features about lost and found situations 123 and metadata for accelerating recovery 124. Private data 121 is supposed to be in various embodiments preferably composed by encrypted features 125 about owners and properties, but can also comprise some public coordinates to arrange meetings between owners and finders. The set of variables included in FIG. 12 is intended to be considered as an initial approach to the recovery process management for some embodiments and can be extended or even reduced as desired according to different implementations.

As already mentioned, both decentralized systems and methods for facilitating the recovery of missing properties can be established in some embodiments via one or more smart contracts that can be placed and run on top of some distributed ledger or blockchain. In that case, both the backend system and the database can be defined in one or more smart contracts by different variables and functions to be accessed by owners and finders of properties. In those embodiments, functions that run on mentioned ecosystems can be composed by code that can be executed with global consensus on a virtual machine (e.g., Ethereum Virtual Machine) whenever they are run. Therefore, in one or more embodiments the system logic can be defined via one or various smart contracts that can be deployed into some blockchain (e.g., Ethereum) to be accessed by agents that have the right to access the said blockchain.

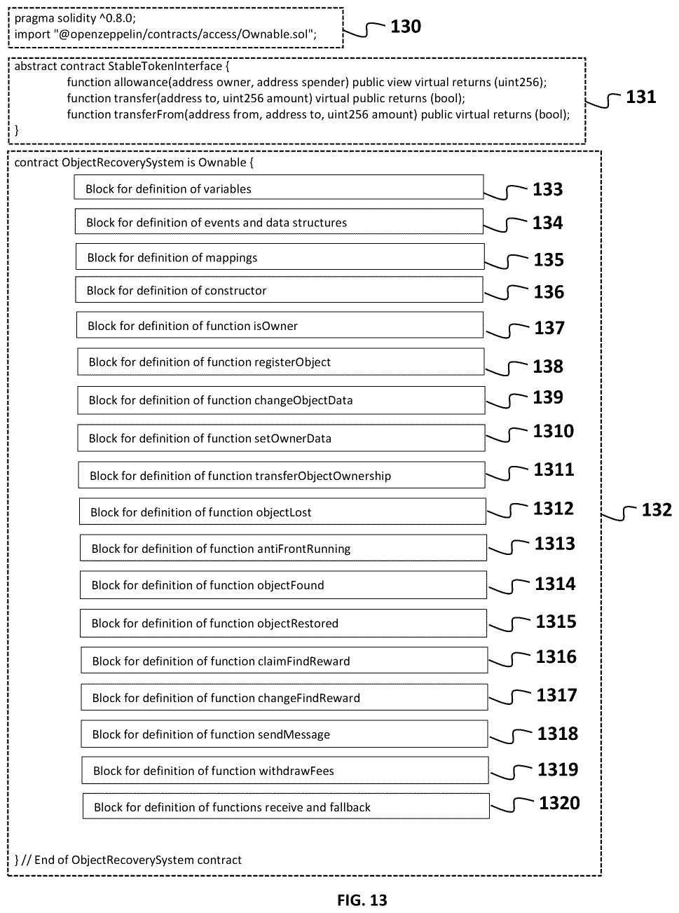

In the following part of the description, some smart contracts and their code sentences are presented and described as an example of one of the many possible ways of implementing both the decentralized system and the methodologies described in the present disclosure for facilitating finding and recovery of missing objects. The inclusion of the mentioned implementation is not intended to limit the scope of the disclosure, but to illustrate the way different possible embodiments can be established. In that context, a scheme of Solidity code representing a main system contract called ObjectRecoverySystem as a possible backend implementation of some embodiments is shown in FIG. 13. The smart contract described herein for representing the recovery system is capable of considering both fixed and replaceable recovery codes for physically identifying properties.

In FIG. 13, the “pragma” and “import” sentences 130 are declared first and a simple interface for defining the interaction with an ERC-20 token contract 131 is declared next. The “pragma” sentence has information regarding the required version of the compilation engine and the “import” line is included for importing the “Ownable” contract from the open source ‘openzeppelin’ library to use the “Ownable” modifier that is well-known by people skilled in the art.

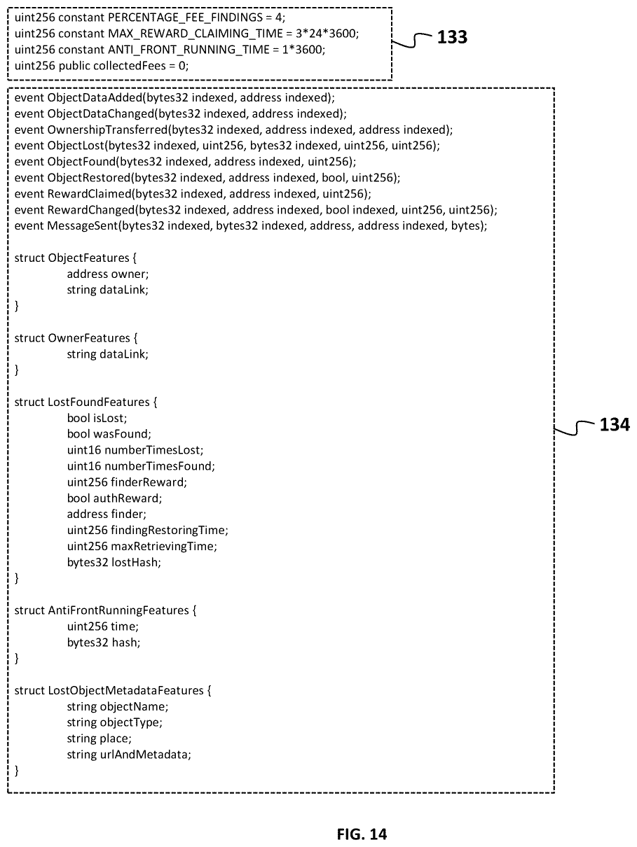

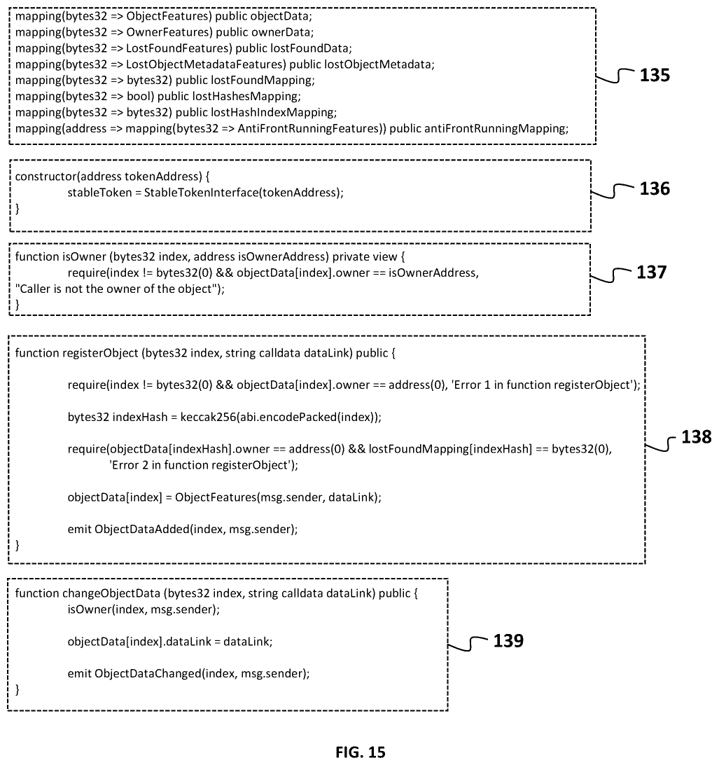

The main code of the contract 132 is divided into different sections of code. Block 133 contains definitions of some variables (FIG. 14), block 134 contains definitions of events and data structures (FIG. 14), block 135 contains definitions of mappings and block 136 contains a definition for the constructor of the contract (FIG. 15).

Block 137 contains a utility private function for verifying whether a user is the owner of an object or not (FIG. 15).

Block 138 contains a public function for registering a new object in the system (FIG. 15).

Block 139 contains a public function for changing data related to an owner's object (FIG. 15).

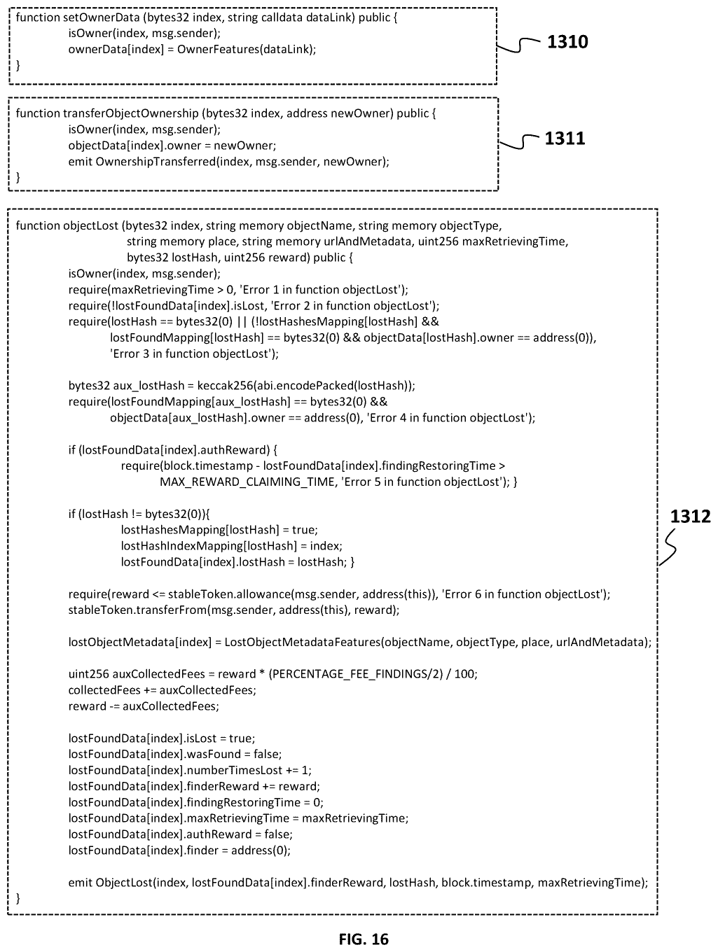

Block 1310 contains a public function for setting data related to the owner of an object (FIG. 16).

Block 1311 contains a public function that allows the owner of an object to transfer the object's ownership to another agent, that can be useful in many embodiments for selling an item or for letting owners give some objects as gifts (FIG. 16).

Block 1312 contains a public function for letting an owner report some object as lost (FIG. 16), allowing the owner to add some metadata related to the lost object (i.e., name, type, place where got lost, web site, etc.).

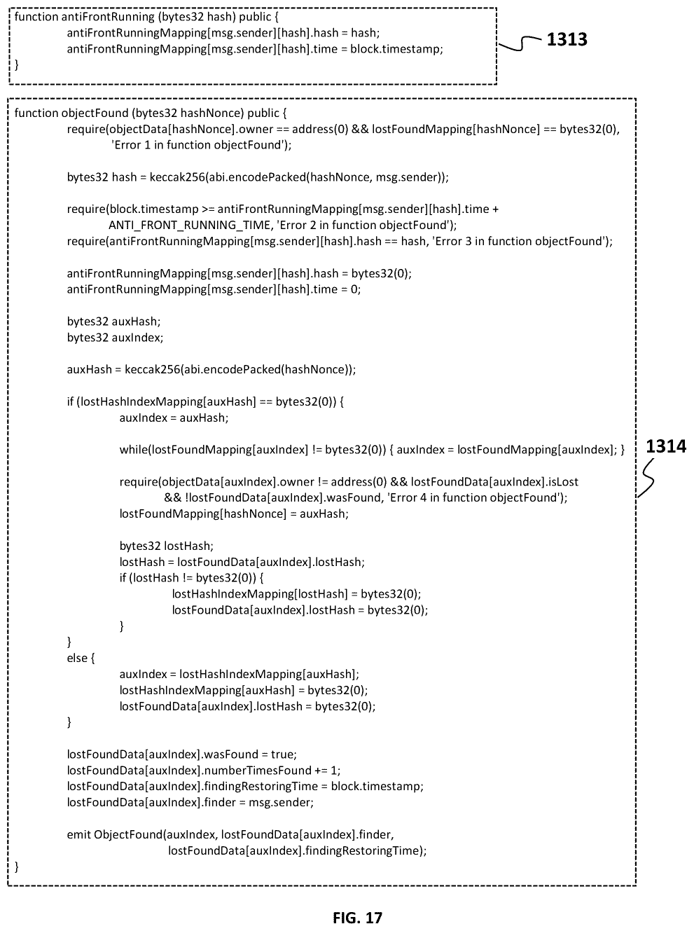

Block 1313 contains the definition of the anti-front-running public function (FIG. 17) that will be explained later.

Block 1314 contains a public function to let a finder report some object as found (FIG. 17).

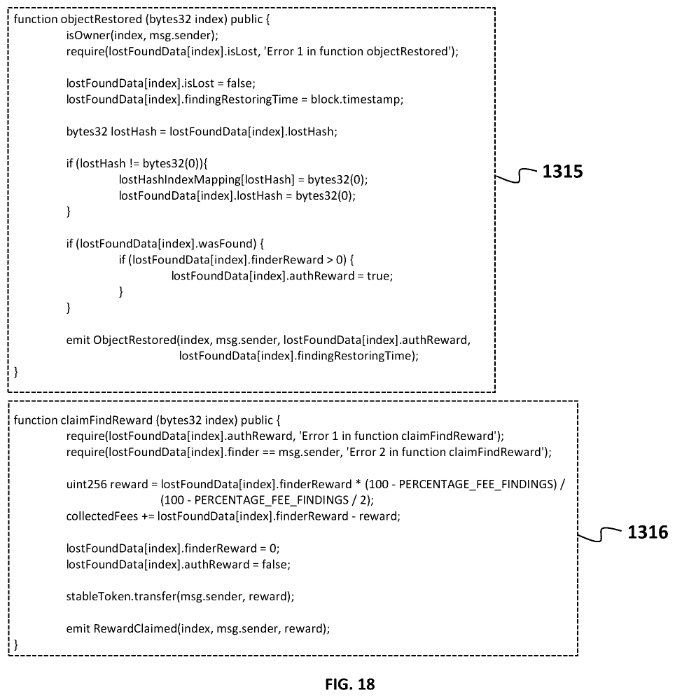

Block 1315 contains a public function to let the owner of an object report the later as restored (FIG. 18).

Block 1316 contains a public function to let a finder claim its find reward, whenever applicable (FIG. 18).

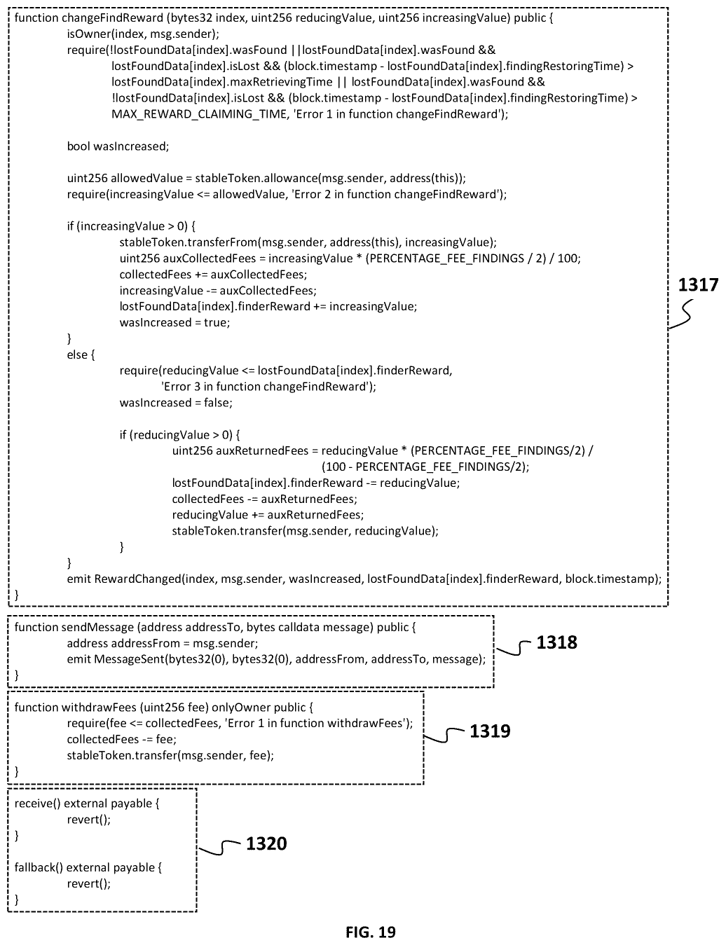

Block 1317 contains a public function to let the owner of an object change the find reward before the object has been found, if the object was not retrieved in a certain time or after some time without claiming the find reward (FIG. 19).

Block 1318 contains a public function to let some user send a message to another agent in the system (FIG. 19).

Block 1319 contains a public function to let the owner of the recovery system withdraw its cumulated fees if any (FIG. 19).

Block 1320 contains some utility functions for avoiding money from getting lost in the system when there are user errors in some function calls (FIG. 19).

System logic defined in the mentioned ObjectRecoverySystem smart contract is done, among other ways, by ensuring certain conditions are met during execution of functions via “require” statements, which revert operations in the virtual machine in case some conditions don't take place, and by setting system variables and transferring payments. When operations are reverted in “require” sentences executed inside contract functions, error messages raise to let users know the type of involved errors via some user app alerts.

In the mentioned contract shown as an example of some embodiments' backend, many variables are arranged in structures established inside mappings indexed by public index variables of objects. Some of the mentioned mappings are leveraged for saving codes already used by agents in the system, thus avoiding repetition of find report codes and object indexes.

Automatic execution of the KECCAK-256 hash function for verification purposes is performed in the mentioned implementation via the “keccak256” built-in Ethereum routine.

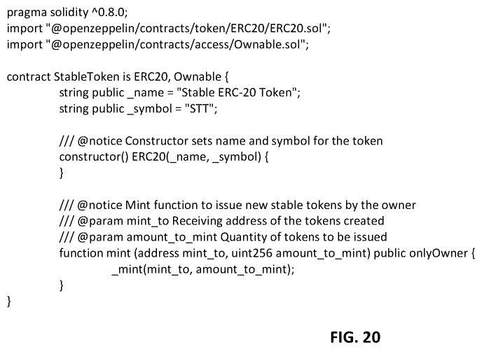

In FIG. 20 the code related to the previously mentioned ERC-20 token contract called StableToken and used as a stable currency in the testing environment of the mentioned implementation is shown. In order for the recovery system capabilities to work properly in some embodiments, incentives for finding objects should be stable so that price fluctuations of the blockchain native token don't affect transactions, as operation timeframes could be as large as days, weeks or months. As people skilled in the art may notice, a possible solution for such an inconvenient in some embodiments may be accepting stable token payments in the main system contract 100% convertible to fiat currencies (e.g., DAI token) when paying and withdrawing find rewards.

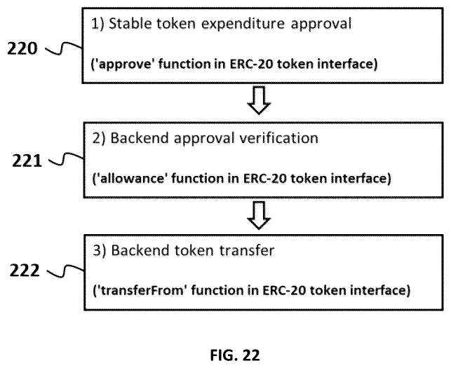

The StableToken contract considered in the mentioned implementation accounts for the later and simulates a stable currency in the ecosystem for making payments. In FIG. 22 three public functions of the ERC-20 token interface used in the mentioned implementation are shown. By using the functions “approve” 220, “allowance” 221 and “transferFrom” 222, spending approvals and payments can be correctly managed in the system, as people skilled in the art may notice.

Before or after a certain property is missing, the property's owner can register the object in the described implementation by calling the registerObject function 138, which emits an ObjectDataAdded event to alert users. During the mentioned process, the owner of the object is capable of setting data related to the object and the owner itself.

Data can also be changed via functions changeObjectData 139 and setOwnerData 1310. The function changeObjectData 139 emits an ObjectDataChanged event at the end of its execution.

After registering the information related to the object and the owner, the later can report the object as lost in the system by calling the objectLost function 1312 which emits an ObjectLost event, setting a maximum time for the recovery process and leaving a find reward as a payment guarantee if desired.

From the moment an object is declared as lost till the moment the object is found, the owner is free to change and also to remove the find reward in the mentioned implementation by executing the changeFindReward function 1317 which emits a RewardChanged event.

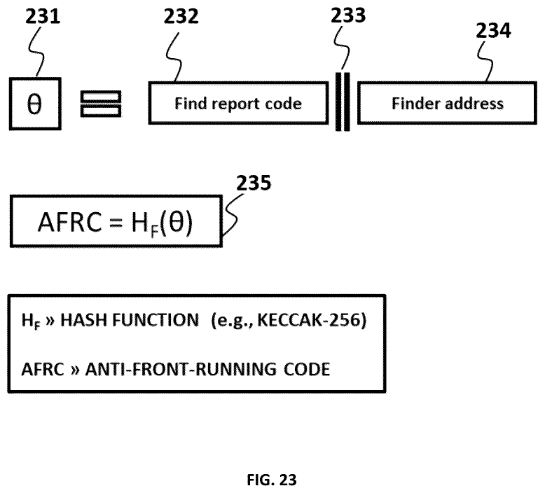

If a certain object was found by someone and its recovery code was successfully read, the function objectFound 1314 can be executed at a certain time by the finder using the generated find report code as an argument. However, there may be some risk in the ecosystem that a third party can concrete the operation before the finder, since transactions may be waiting in a transaction pool for several minutes in the mentioned smart contract blockchain till being mined into a new block. So, the find report code can easily be known by a large number of agents before the objectFound function 1314 is effectively executed by the finder in the virtual machine. The mentioned practice consisting in taking advantages of other's transaction is known as front-running. To prevent such things, a method illustrated in FIG. 23 that is included in the described implementation and that can be considered in various embodiments is shown.

In the mentioned system implementation, after an object is found by a finder but prior being reported as found using the objectFound function 1314, the finder must call the antiFrontRunning function 1313 sending an anti-front-running code 235 as argument. The anti-front-running code 235 equals to the hash calculation (e.g., KECCAK-256) applied on a code θ 231. The code θ 231 is the result of applying a concatenating operator 233 between the derived find report code 232 and the finder address 234.

Therefore, people skilled in the art will notice that there is no way for other agents to generate an anti-front-running code for reporting the same finding since the find report code is unknown for everyone except for the finder and the owner. In the mentioned implementation, after calling the antiFrontRunning function 1313 with the anti-front-running code 235 as argument, the finder must wait some predetermined delay time (i.e., one hour) for having some priority on calling the objectFound function 1314 and effectively report the object as found, reducing the likelihood of front-running in the operation.

People skilled in the art will notice that the objectFound function 1314 working together with system variables and mappings is perfectly capable of verifying at runtime that properties were correctly found based on both fixed and replaceable recovery codes used for identification. In the case of a fixed recovery code 70 placed in a property, part or the whole hash chain 64 is verified during execution till getting the public index of a property 78 registered in the system based on a proper find report code provided by a finder. If a replaceable recovery code 40 is considered for identification, the mentioned function is able to verify at runtime that the public verification variable 45 derived from a find report code 43 provided by some finder matches a system variable previously set by some owner of a property.

Once the delay time has passed and the objectFound function 1314 was executed by the finder, the system can automatically verify that the find report code matches the code masked inside the anti-front-running code previously generated by the finder and that the find report code is related to an object reported as lost. If those conditions are met, then an ObjectFound event is emitted in the implementation to alert the whole ecosystem and the object's owner about the finding.

The mentioned predetermined delay time the finder must wait till reporting the object as found for various embodiments is proposed to be such a number so that finders have a certain priority time for reporting findings without being front-run by other agents. For example, if preset minimum waiting time for finders is long enough in a certain embodiment in relation to time between blocks in the blockchain in which the contract was deployed to, then front-running turns unlikely in the said system. For instance, in the Ethereum blockchain each block is approximately mined after 6 minutes. Therefore, a waiting time of about one hour could be considered enough in that ecosystem to prevent front-running and avoid false alarms on found objects for different embodiments.

In the mentioned implementation, once a property was reported as found, the finder has up to a maximum time set by the owner to retrieve the object. If there are no stored contact details to contact the object's owner, the finder can send a message via the decentralized network to the owner by executing the sendMessage public function (routine 1318 in FIG. 19) which emits a MessageSent event.

If time exceeds the maximum recovery time in the implementation, the owner can freely withdraw the find reward. Otherwise, if the object is recovered by its owner, the later can inform the ecosystem about the event via the objectRestored function 1315 emitting an ObjectRestored event for letting the finder withdraw its reward if applicable.

To withdraw the find reward, the finder can call the claimFindReward function 1316 (FIG. 18) to ask the system to transfer the find reward amount to the finder's account, after which a RewardClaimed event is emitted. If the finder doesn't want a payback in exchange, the later can donate the find reward to a third party or organization by transferring the received amount. In some embodiments, some variations could be taken into account in relation to the programming code of function 1316 to let donations be automatically paid to third parties during the execution of the mentioned function.

In the said implementation, the main recovery system contract is owned by the agent that deployed the contract to the correspondent blockchain. As the owner of the system, the mentioned agent can charge fees on operations that take place in the network. As an example, a certain fee is charged in the ObjectRecoverySystem contract when an object is reported as lost by its owner and when a lost object is finally retrieved as a fixed percentage of the find reward. A public function named withdrawFees 1319 is included in the contract to let the owner of the contract withdraw its cumulated fees (FIG. 19). However, other kind of fees could be possibly charged in other embodiments, like a fee for registering new objects or a custom fee as a function of the maximum number of times an object can be lost and retrieved in the system, among others.

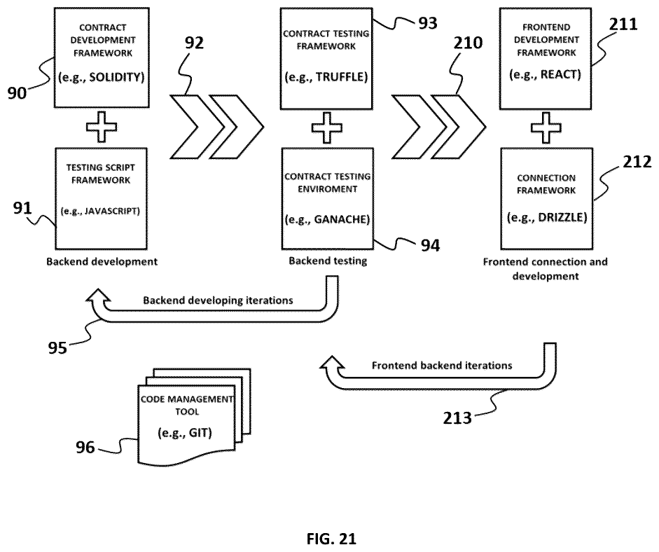

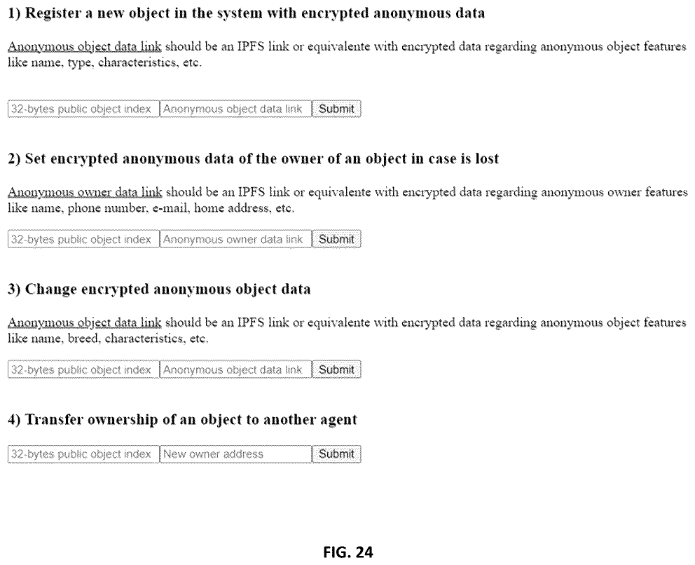

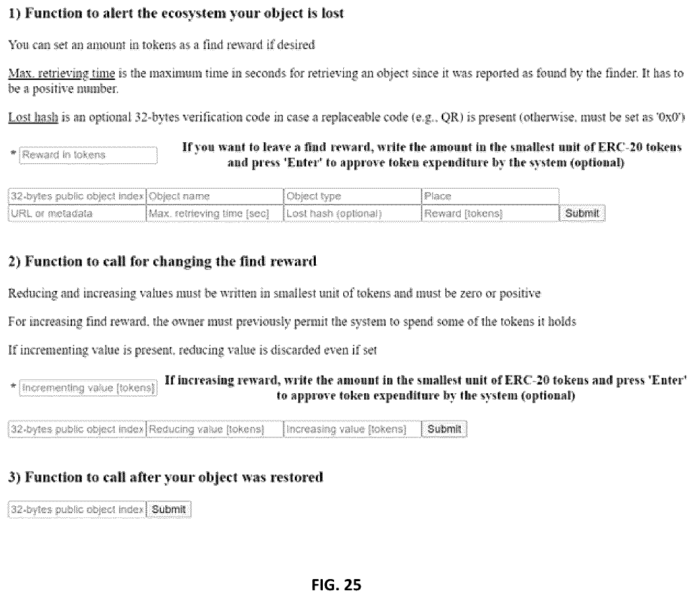

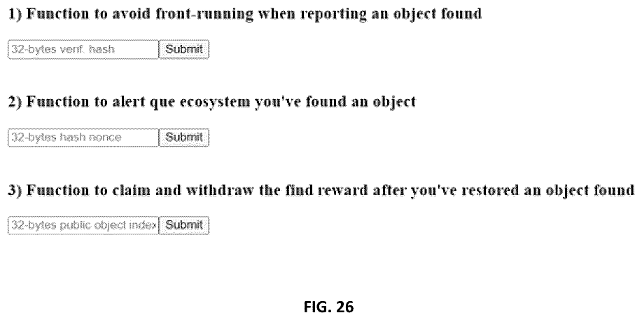

After both smart contracts implied in the described implementation of the decentralized recovery system (i.e., ObjectRecoverySystem and StableToken) are successfully migrated to a testing environment (e.g., Ganache-CLI), some testing scripts can be run for correcting errors and ensuring all functions and variables behave as expected before deploying the contracts to a public blockchain. Also, a frontend interface web site app can be developed as can be schematically seen in FIG. 21 to test the whole system at step 210 from a user point of view and to demonstrate how an interface app may be implemented as the system frontend. A frontend development framework 211 (e.g., React) and a connection framework 212 (e.g., Drizzle) may be leveraged together with some iteration loop 213 to test the whole system functionalities from a user point of view. Source code of a frontend interface for testing the backend system of the described implementation is not included in the present disclosure for simplification, but two sections of a system web site app are shown for illustration of simplistic frontends of some possible embodiments. Therefore, FIG. 24 shows one of the app sections for registering new objects and setting data from objects and owners in one possible embodiment. FIG. 25 shows a web site section of the frontend of one possible embodiment including functions that can be executed by owners of properties for reporting properties as lost and restored, and for changing find rewards. FIG. 26 shows a web site section of the frontend of one possible embodiment including functions that can be executed by finders of missing properties for reporting properties as found and for claiming find rewards.

The mentioned sections of a web site app are shown herein as an example to prove how interaction between agents and the system may be done in various embodiments. However, it is expected that user-friendly apps for cell phones, tablets, laptops, among other devices, may be developed for different embodiments.

After the system and its functions for a certain embodiment is fully tested from backend and user points of view, the system can be deployed to some public network. In the case of the smart contracts recently described as examples of possible embodiments, they could be easily deployed to the Ethereum blockchain.

The smart contracts above-described comprise one of the possible ways for implementing the systems and methods disclosed herein. However, many other embodiments can be created based on disclosed concepts for facilitating finding and recovery of missing properties by using different ecosystems, databases, distributed ledgers, programming languages and recovery strategies, among other tools.

Based on the disclosed features, an environment and a market may be created thanks to some embodiments in which owners and finders of properties can freely interact with proper incentives to facilitate finding and recovering of missing items, both lost and stolen. Since find rewards can be paid and interaction can take place in a decentralized way, a high level of anonymity can be reached, thus encouraging more operations to take place for finding and retrieving items in relation to systems of the prior art.

If adequately combined with different laws and regulations, the systems and methodologies established in the current disclosure could let governments and justice institutions from different countries deploy their own decentralized applications to allow and enhance people to recover stolen properties by themselves when applicable.

Furthermore, some companies and organizations could leverage some aspects of the current disclosure by deploying apps and registering items before being sold to the market, allowing properties to be recovered from the moment of sale if missing. Insurance companies could also leverage some of the characteristics of the current disclosure by including possible finding and retrieval operations in insurance policies and also by assigning reward payments for trying to recover missing properties before covering them.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This detailed description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

While the methods disclosed herein have been described and shown with reference to particular operations performed in a particular order, it will be understood that in some cases these operations may be combined, sub-divided, or re-ordered to form equivalent methods without departing from the teachings of the present invention. Accordingly, unless specifically indicated herein, the order and grouping of the operations is not a limitation of the present invention. For instance, as a non-limiting example, in alternative embodiments, portions of operations described herein may be re-arranged and performed in different order than as described herein.

In this document, the terms “a” or “an” are used, as is common in patent documents, to include one or more than one, independent of any other instances or usages of “one or more.” In this document, the term “or” is used to refer to a nonexclusive or, such that “A or B” includes “A but not B,” “B but not A,” and “A and B,” unless otherwise indicated. In the appended claims, the term “comprising” is open-ended; that is, a system, device, article, or process that includes elements in addition to those listed after such a term in a claim is still deemed to fall within the scope of that claim.

What is claimed is:

1. A decentralized system for facilitating finding and recovery of lost and stolen properties, the system comprising:
one or more functions and variables to let a user register a property in the system by using an index associated to the property, the index comprising one or more data structures;
one or more functions and variables to set the user as the owner of the property in the system;
one or more functions and variables to let the owner report the property as missing in the system to account for situations of both lost and stolen properties;
one or more functions and variables to let the owner store public and/or private information in the system for accelerating the finding of the property when missing and for retrieving and/or taking care of the property after found;
one or more functions and variables to let an agent report the missing property as found in the system by using a find code, the find code comprising one or more data structures; and
one or more functions and variables to let the owner report the missing property as retrieved in the system.

2. The system of claim 1, wherein the system is deployed to a distributed ledger or blockchain for storing all variables and functions and for executing those functions, the distributed ledger or blockchain comprising:
an adequate technology for reaching consensus about rights related to the system variables and functions through a suitable representation of them using smart contracts or similar approaches, and
a means for accessing the system by users that have the right to interact with the system for reading variables or executing some of its functions.

3. The system of claim 2, further comprising:
one or more functions and variables to let the owner of the system charge some fees on certain operations in the system and withdraw its cumulated fees; and
a set of functions and variables that can be used to reduce the probability of front-running in the system when reporting a missing property as found, comprising:
at least two routines that must be executed at different times by an agent willing to successfully report the missing property as found, and
a minimum predefined delay time between the execution of the two routines,
wherein the time is great enough for reducing the probability of front-running as much as desired.

4. The system of claim 3, wherein:
the first of the routines that must be called in first place by the agent willing to successfully report the missing property as found is a system function capable of receiving at least one argument when executed, the argument comprising an anti-front-running code composed by one or more data structures, wherein:
the anti-front-running code can be generated by the agent,
the anti-front-running code can be stored in the system when the routine is executed, and
the anti-front-running code can be derived by the application of one or more routines in a batch processing scheme, wherein:
at least one of the routines is a hash function hard to be inverted, and
the hash function is applied on a data structure, the data structure comprising, among other possible things:
the find code used to report the missing property as found, and
the address in the system of the agent; and
the second of the routines that must be called in second place by the agent willing to successfully report the missing property as found is a system function capable of receiving at least one argument when executed, the argument comprising a data structure composed at least by the find code used to report the missing property as found, the routine comprising:
one or more algorithms in a batch processing scheme capable of obtaining the anti-front-running code,
one or more algorithms to verify if the time between the execution of the two routines is greater than the minimum predefined delay time, and
one or more algorithms to verify that the probability of occurrence of the front-running event has been reduced as much as desired.

5. The system of claim 1, further comprising:
one or more functions and variables that can be used by the owner of the property to leave a find reward if desired for being withdrawn in case the property is successfully found and retrieved by any agent after being declared as missing; and
one or more functions and variables that can used by any agent after finding and retrieving a missing property in order to withdraw or donate the find reward if any.

6. The system of claim 5, further comprising:
one or more functions and variables that can be used by the owner of the property to modify a find reward by increasing/decreasing the amount of reward left when applicable, if the associated missing property has not been reported as found till that moment.

7. The system of claim 5, further comprising:
one or more functions and variables that can be used by the owner of the property to partially or totally withdraw a find reward associated to the missing property, if a certain predefined amount of time defined by the system or the owner has gone by after the property was reported as retrieved by its owner and the find reward has not been withdrawn or donated till that moment by the agent who reported the property as found; and
one or more functions and variables that can be used by the owner of the property to partially or totally withdraw a find reward associated to the missing property, if a certain predefined amount of time defined by the system or the owner has gone by after the property was reported as found and the property has not been reported as retrieved till that moment.

8. The system of claim 1, wherein:
the recovery code associated to the property is a fixed recovery code that is hard to be removed from the property or replaced by another code;
a private key, N find codes and the index can be derived by any agent from the fixed recovery code, being N the maximum number of times the property can be reported as missing and then found in the system;
the private key can be used by the owner of the property to encrypt information related to it and/or its owner if desired;
the index can be used by the owner of the property to reference data associated to it in the system after the property was registered and to report the property as missing;
the N find codes can be used by finders of the property at different times for reporting the property as found when missing; and
the index can be used by the system to verify the finding of the property when missing based on one of the find codes at a certain time.

9. The system of claim 1, wherein:
the recovery code associated to the property is a replaceable recovery code that is easy to be removed from the property and replaced by another code by its owner;
a private key, a find code and a verification variable can be derived by any agent from the replaceable recovery code;
the private key can be used by the owner of the property to encrypt information related to it and/or its owner if desired;
the verification variable and the index can be used by the owner of the property to report it as missing;
the find code can be used by a finder of the property for reporting the missing property as found; and
the verification variable can be used by the system to verify the finding of a missing property based on the find code.

10. The system of claim 8, wherein:
the private key is obtained after the application of an algorithm on the fixed recovery code, the algorithm comprising one or more routines combined in a batch processing scheme wherein there is at least one routine that is a key derivation algorithm, so that a certain minimum computational cost is needed to derive the private key from the fixed recovery code;
the find code for reporting the finding of the property for the N^{th} time is obtained after the application of an algorithm on the fixed recovery code, the algorithm comprising one or more routines combined in a batch processing scheme wherein there is at least one routine that is a key derivation algorithm so that a certain minimum computational cost is needed to derive the find code;
the find code for reporting the finding of the property for the i^{th} time, being i greater than 0 and smaller than N, is obtained after the application of an algorithm on the find code for reporting the finding of the property for the i+1^{th} time, the algorithm comprising one or more routines combined in a batch processing scheme wherein there is at least one routine that is a hash function hard to be inverted, the routines consisting of instructions than can be executed by the decentralized system inside some system function call; and
the index is obtained after the application of an algorithm on the find code for reporting the finding of the property for the first time, the algorithm comprising one or more routines combined in a batch processing scheme wherein there is at least one routine that is a hash function hard to be inverted, the routines consisting of instructions than can be executed by the decentralized system inside some system function call.

11. The system of claim 9, wherein:
the index is randomly generated by the owner of the property;
the private key is obtained after the application of an algorithm on the replaceable recovery code, the algorithm comprising one or more routines combined in a batch processing scheme wherein there is at least one routine that is a key derivation algorithm, so that a certain minimum computational cost is needed to derive the private key from the replaceable recovery code;
the find code is obtained after the application of an algorithm on the replaceable recovery code, the algorithm comprising one or more routines combined in a batch processing scheme wherein there is at least one routine that is a key derivation algorithm so that a certain minimum computational cost is needed to derive the find code; and
the verification variable is obtained after the application of an algorithm on the find code, the algorithm comprising one or more routines combined in a batch processing scheme wherein there is at least one routine that is a hash function hard to be inverted, the routines consisting of instructions than can be executed by the decentralized system in some system function call.

12. A method for facilitating finding and recovery of missing properties in a decentralized system, the method comprising:
placing a fixed or a replaceable recovery code in a property for identification;
registering a property in the system by a user via an index derived from the fixed recovery code if associated to the property or randomly selected otherwise, the index comprising one or more data structures;
assuming that the user is the owner of the property in the system;
using the index by the owner of the property if desired to reference public and/or private data associated to it in the system after the property was registered;
reporting the property as missing by its owner, for taking account of both lost and stolen properties;
reporting the missing property as found by an agent using a find code, the find code comprising one or more data structures; and
reporting the missing property as retrieved by its owner.

13. The method of claim 12, further comprising:
leaving a find reward in the system by the owner of the missing property if desired for it to be withdrawn by a future finder of the property after being reported as retrieved; and
withdrawing or donating the find reward if any by the finder of the property after being reported as retrieved.

14. The method of claim 13, further comprising:
modifying the find reward associated to the missing property by its owner by increasing/decreasing the amount in case applicable, if the property has not been reported as found by any agent up to that moment.

15. The method of claim 13, further comprising:
withdrawing partially or totally the find reward associated to the missing property by its owner, if a certain amount of a predefined delay time defined by the system or the owner has gone by after the missing property was reported as retrieved and the find reward has not been withdrawn or donated by the finder of the property till that moment; and
withdrawing partially or totally the find reward associated to the missing property by its owner, if a certain amount of a predefined delay time defined by the system or the owner has gone by after the property was reported as found and if it has not been reported as retrieved till that moment.

16. The method of claim 12, further comprising some steps for avoiding front-running in the system when reporting a missing property as found, the steps comprising:
generating an anti-front-running code by an agent willing to report the missing property as found by applying a hash function on a data structure composed at least by the find code of the property and the address of the agent in the system;
executing a first function in the system by the agent using the anti-front-running code as one of the arguments to ensure a certain priority when reporting the property as found;
waiting a certain minimum predefined delay time after executing the first function till executing a second function; and
executing the second function by the agent using the find report code as one of the arguments to report the property as found in the system, claiming priority in relation to other users for avoiding front-running.

17. The method of claim 12, further comprising:
storing public information in the system by the owner of the property if desired related to it and/or its owner or publishing a link that refers to the mentioned information externally stored;
using the public information if desired for accelerating the finding and/or recovery process of the property when missing and/or for taking care of the property after being found;
storing private information in the system by the owner of the property if desired related to it and/or its owner, wherein the information can be human-readable or can be the result of the application of an encryption process on human-readable data by the owner using a private key, or publishing a link in the system that refers to the mentioned information externally stored;
using the private information if desired for accelerating the recovery process of the property and/or for taking care of the property after being found;
modifying the public information or modifying the link that refers to the externally stored information by the owner of the property if desired; and
modifying the private information or modifying the link that refers to the externally stored information by the owner of the property if desired.

18. The method of claim 12, further comprising:
generating a private key, N find codes and the index derived from the fixed recovery code if placed in the property, being N the maximum number of times the property can be reported as missing and then found in the system;
using the private key by the owner of the property to encrypt private information related to it and/or its owner if desired; and
using the N find codes by finders of the property for reporting the property as found when missing at different times.

19. The method of claim 12, further comprising:
generating a private key and a find code derived from the replaceable recovery code if placed in the property;
generating the index in a random way;
using the private key by the owner of the property to encrypt private information related to it and/or its owner if desired; and
using the find code by a finder of the property for reporting the property as found when missing.

20. A method for placing a replaceable recovery code in the lock screen of a device for proper identification and recovery of the property when missing through a decentralized recovery system, the method comprising:
generating a random code of a certain minimum length by the owner of the property through an app installed in the device;
deriving a graphic representation of the random code using the app;
placing the graphic representation of the random code in a secondary hidden lock screen of the device together with proper instructions for an eventual finder to follow, so that the secondary hidden lock screen is visible after shifting the main lock screen by some user or through a certain combination of pushed buttons or similar strategies;
using the graphic representation of the random code by an eventual finder of the device for facilitating the recovery of the missing property through a decentralized recovery system; and
replacing the code and its graphic representation in the secondary hidden lock screen of the device by a new code randomly generated and its associated graphic representation using the app by the owner of the missing property after recovery.
